(19) United States
(12) Patent Application Publication
(10) Pub. No.: US 2017/0079316 A1
(43) Pub. Date: Mar. 23, 2017

(54) MECHANICAL GENERATION OF FLAVOUR COMPOSITIONS

(71) Applicant: NESTEC S.A., Vevey (CH)

(72) Inventors: Florian Viton, Lausanne 26 (CH); Heiko Roberto Oertling, Lausanne (CH); Rene Fumeaux, Blonay (CH)

(21) Appl. No.: 15/310,628

(22) PCT Filed: May 12, 2015
(86) PCT No.: PCT/EP2015/060530

§ 371 Date: Nov. 11, 2016

(30) Foreign Application Priority Data
May 19, 2014 (EP) 14168814.3

(51) Int. Cl. A23L 27/21; A23L 33/10; A23L 2/56

(52) U.S. Cl. CPC A23L 27/21; A23L 2/56; A23L 33/10; A23V 2002/00

(57) ABSTRACT

The present invention relates to flavour generation. In particular the invention relates to a process for generating a flavour composition. The process comprises milling a mixture comprising flavour precursors in the solid state. A further aspect of the invention is a food product comprising the flavour composition obtainable by the process of the invention.

The present invention relates to flavour generation. In particular the invention relates to a process for generating a flavour composition. The process comprises milling a mixture comprising flavour precursors in the solid state. A further aspect of the invention is a food product comprising the flavour composition obtainable by the process of the invention.

Reaction flavours, sometimes called process flavours, are complex building blocks that provide similar aroma and taste properties to those found in thermally treated foodstuffs such as meat, chocolate, coffee, caramel, popcorn and bread. Traditionally, flavour compounds are produced thermally in solution, most commonly in a buffered water system at a certain pH. The complex chemistry behind those flavour generating reactions is commonly termed “Maillard” chemistry. This has been described by many sources [M. K. Sucan et al., “Process and Reaction Flavors”, ACS Symposium Series 2005, 905, 1-23]. Most commonly the desired key value molecules are generated by mixing a reducing sugar and an amino acid in the respective matrix and heating for a certain period of time. WO2008148737 for example describes adding flavour precursors (amino acids and reducing sugars) directly to ingredients which are then baked to form baked foodstuffs.

When generating a process flavour, a mixture of several key aroma compounds is usually formed. This does not just depend on the nature of the flavour precursor materials, but also on the process used and the reaction medium. Different aroma compound mixtures provide different sensory characteristics. There is a need to provide new flavour generation processes which can efficiently generate desirable mixtures of aroma compounds.

When process flavours are produced in solution there is often the need to remove some or all of the solvent before adding the flavours to a foodstuff. This can be expensive in terms of energy usage, as can heating the reaction mixtures to generate the reaction. Typically thermally processed flavors are spray-dried or concentrated via spinning cone columns (to strip off the solvent) after their actual production and this is technically challenging as removing the solvent or the carrier will at the same time remove desired target compounds (as they are volatiles). It would be desirable to have a simpler and/or more energy efficient process for generating process flavours.

Mechanochemistry refers to reactions induced by the input of mechanical energy, such as by milling in ball mills. Mechanochemistry can promote reactions between solids quickly and quantitatively, with either no added solvent or only nominal amounts. A number of chemical syntheses may be performed in this way [S. L. James et al., Chem. Soc. Rev., 41, 413-447 (2012)].

An object of the present invention is to improve the state of the art and to provide an improved process for the preparation of flavour compositions or at least to provide a useful alternative. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

The present invention provides in a first aspect a process for generating a flavour composition comprising milling a mixture comprising flavour precursors in the solid state and between 0.0001 and 10 wt. % edible solvent, wherein the flavour precursors in the solid state comprise at least one polyol with at least one amino compound selected from the group consisting of amino acids, amino acid derivatives and peptides and wherein the total weight in the solid state of polyols and amino compounds selected from the group consisting of amino acids, amino acid derivatives and peptides is at least 20% of the weight of the milled mixture. In a second aspect, the invention relates to a food product comprising the flavour composition obtainable by the process of the invention.

It has been surprisingly found by the inventors that flavour precursors in the solid state may be reacted together to generate flavours by the application of mechanical energy. For example, when crystalline rhamnose monohydrate (a reducing sugar) is milled in a ball mill with crystalline proline (an amino acid) a pleasant aroma with baked and popcorn notes is generated. This is different from the known thermal generation of flavours from proline and rhamnose in solution as, not only are the flavour precursors in the solid state, but the aroma may be generated when the milling is performed at a temperature below 40° C. Generating flavours by the application of mechanical energy provides a number of advantages. Mechanical processing of solids is more efficient than conventional processes where the flavour precursors are dissolved, solid state flavour generation may avoid or reduce the need for post-process drying, also, mechanical processes offer the capacity to form solid flavour precursors into extremely well pre-organised systems which can allow a better control of flavour generation. The profile of aroma compounds produced is also different from that obtained by conventional thermal treatment in solvent systems such as water.

### BRIEF DESCRIPTION OF THE DRAWINGS

FIG. 1 shows the relative headspace quantification of Maillard products generated from Rhamnose and Proline; left column: ball-milled samples, right column: manually mixed. 2-AP stands for 2-Acetyl-1-pyrroline, 2,5-DF for 2,5-Dimethylfuran and DMPF for 2,5-Dimethyl-4-(1-pyrrolidinyl)-3(2H)-furanone respectively.

FIG. 2 shows the aroma intensity measured by a sensory panel for baked wafers having proline and rhamnose prepared in different ways; (a) no treatment, (b) milled separately and (c) milled together.

FIG. 3 shows aroma intensity measured by a sensory panel for baked wafers having proline and rhamnose prepared in different ways; (a) no treatment, (b) micronized, (c) micronized and ball milled, and (d) micronized and ball milled with small amount of water.

FIG. 4 shows SPME analysis of furaneol in baked wafers having proline and rhamnose prepared in different ways; (a) no treatment, (b) micronized, (c) to micronized and ball milled, and (d) micronized and ball milled with small amount of water.

### DETAILED DESCRIPTION OF THE INVENTION

The present invention relates in part to a process for generating a flavour composition comprising milling a mixture comprising flavour precursors in the solid state and between 0.0001 to 10 wt. % edible solvent, wherein the flavour precursors in the solid state comprise at least one polyol with at least one amino compound selected from the group consisting of amino acids, amino acid derivatives and peptides and wherein the total weight in the solid state of polyols and amino compounds selected from the group consisting of amino acids, amino acid derivatives and peptides is at least 20% of the weight of the milled mixture (for example at least 50% of the weight of the milled mixture, for further example at least 75% of the weight of the milled mixture). The ratio of polyols to amino compounds in the flavour precursors of the current invention may be between 1:0.1 and 0.1:1. An amino acid derivative is a compound that is derived from an amino acid compound by some chemical process. An example of an amino acid derivative is dihydroxyphenylalanine, a beta-hydroxylated derivative of phenylalanine. The at least one amino compound may be selected from the group consisting of amino acids and peptides. The at least one amino compound may be free amino acids.

The process for generating a flavour composition according to the invention may comprise milling a mixture comprising flavour precursors in the solid state and between 0.0001 and 10 wt. % edible solvent so as to generate aroma compounds, wherein the flavour precursors in the solid state comprise at least one polyol with at least one amino compound selected from the group consisting of amino acids, amino acid derivatives and peptides and wherein the total weight in the solid state of polyols and amino compounds selected from the group consisting of amino acids, amino acid derivatives and peptides is at least 20% of the weight of the milled mixture.

Milling is the process of breaking solid material into smaller pieces such as in a ball mill. In the present invention, the term milling includes grinding such as in a mortar-grinder. The edible solvent may be any edible liquid in which the flavour precursors are soluble, for example a liquid in which each flavour precursor has a solubility of at least 0.1 g/100 g at 20° C. The quantity of edible solvent in relation to the quantity of flavour precursors should not be so high that the flavour precursors completely dissolve under process conditions; this is a simple matter for the skilled person to adjust. The edible solvent may be present at least in part in a solid form, for example water in the form of crystalline hydrates. The mixture milled in the process of the invention may comprise between 0.0005 and 5 wt. % edible solvent, for example between 0.001 and 2 wt. % edible solvent. The mixture in the process of the invention may be milled so that the D90 value is reduced by at least 5%, for example by at least 10%, for further example by at least 20%. The D90 value is a common method of describing a particle size distribution. The D90 is the diameter where 90% of the mass of the particles in the sample have a diameter below that value. The D90 value may be measured for example by a laser light scattering particle size analyser. At least 0.5 wt. % of the mixture milled in the process of the invention may be flavour precursors in the solid state, for example at least 5 wt. %, for example at least 20 wt. %, for example at least 50 wt. %, for still further example at least 75 wt. %. Milling the flavour precursors causes them to react and be converted to reaction products. The flavour precursors comprised within the mixture milled in the process of the invention may be Maillard reaction precursors. Milling the mixture comprising flavour precursors in the solid state according to the process of the invention may form Maillard reaction products. At least 0.0001 wt. % of flavour precursors may be reacted to Maillard reaction products during milling, for example at least 0.001 wt. % of flavour precursors may be reacted to Maillard reaction products during milling. At least 1 wt. % of the flavour precursors may be reacted during milling, for example at least 5 wt. % of the flavour precursors.

Although some particle size reduction necessarily occurs during milling in the process of the invention, it is the mechanical energy input during the milling process which initiates the generation of aromas from the mixture comprising flavour precursors. The mechanical energy applied during milling in the process of the invention may be greater than 5 Wg⁻¹, for example greater than 10 Wg⁻¹. The milling may be continued after the minimum particle size (e.g. minimum D90) is reached, for example the duration of milling may be at least 1.2 times the duration required to reach minimum particle size, for example at least 1.5 times the duration required to reach minimum particle size, for example at least twice the duration required to reach minimum particle size.

The process for generating a flavour composition may comprise milling a mixture comprising flavour precursors in the solid state and between 0.0001 and 10 wt. % edible solvent so as to reduce the D90 particle size by at least 5%, wherein the flavour precursors in the solid state comprise at least one polyol with at least one amino compound selected from the group consisting of amino acids, amino acid derivatives and peptides.

At least a trace quantity of edible solvent is required for the reaction to proceed. Without wishing to be bound by theory, it is believed that this permits the flavour precursors to adopt the correct configuration for reaction in micro regions of their surface, for example the polyol glucose may fleetingly adopt its open-chain form in the presence of water thus providing a carbonyl group to react with a nucleophilic amino group of an amino acid. The presence of edible solvent may also be beneficial in lubricating the milling action.

The process of the invention may further comprise the step of adding edible solvent to the mixture after milling. The inventors were surprised to find that once the flavour precursors had been milled they would continue to react to form flavours with the addition of further edible solvent. The same effect was not observed to the same extent with flavour precursors that had not been milled together.

The edible solvent used in the process of the invention may be selected from the group consisting of water, glycerol, ethanol, propylene glycol, ethyl acetate, acetone, isopropanol, triethylcitrate, triacetin and mixtures of these. For example, the edible solvent used in the process of the invention may be selected from the group consisting of water, glycerol, ethanol, propylene glycol, ethyl acetate, acetone, isopropanol and mixtures of these. Water is the edible solvent with the greatest acceptability to consumers as a food ingredient. Accordingly, the edible solvent may be water.

The mixture milled in the process of the invention may further comprise a buffer. In the context of the present invention a buffer is a substance or mixture of substances which can adjust or control pH. Controlling pH can be used to adjust the equilibrium between different forms of flavour precursors so as to favour flavour generation. Some aromas are preferentially produced under basic conditions; accordingly the buffer may be an alkali. The buffer may be a solid. The buffer is preferably an edible material. The buffer may be a salt selected from the group consisting of phosphates, citrates, lactates, carbonates, acetates, hydrogencarbonates, hydrogen phosphates and mixtures of these. For example, the buffer may be a salt selected from the group consisting of phosphates, citrates, lactates, carbonates and mixtures of these.

The molar ratio of polyol to amino compound in the mixture milled in the process of the invention may be between 1:0.01 and 1:100. For example the molar ratio of polyol to amino compound may be between 1:0.15 and 1:1.5. For example the molar ratio of polyol to amino compound may be between 1:0.9 and 1:1.1.

The at least one amino compound in the process of the invention may be a source of free amino acids. The amino compound may be selected from the group consisting of glycine, alanine, valine, norvaline, leucine, norleucine, aspartic acid, glutamic acid, asparagine, glutamine, arginine, lysine, serine, threonine, proline, tyrosine, cysteine, cystine, methionine, phenylalanine, histidine, tryptophan, dihydroxyphenylalanine, taurin, thiamine, carnosine, glutathione, their salts and mixtures of these. For example, the amino compound may be selected from the group consisting of glycine, alanine, valine, norvaline, leucine, norleucine, aspartic acid, glutamic acid, asparagine, glutamine, arginine, lysine, serine, threonine, proline, tyrosine, cysteine, cystine, methionine, phenylalanine, histidine, tryptophan, dihydroxyphenylalanine, taurin, thiamine, carnosine, glutathione and mixtures of these. The amino compound may be proline. The amino compound may be lysine. The amino compound may be glycine. These amino compounds are commonly used in reaction flavours for foods, providing attractive flavours at a viable cost.

Providing sulphur compounds in the reaction mixture may be important for the generation of certain aromas, especially meaty aromas. Some amino acids such as cysteine already contain sulphur, but it may be advantageous to add further sulphur containing compounds. The flavour precursors of the process of the invention may further comprise a source of sulphur, for example ammonium sulphide.

The at least one polyol in the process of the invention may be a reducing sugar. A reducing sugar is any sugar that either has an aldehyde group or is capable of forming one in solution through isomerism. Reducing sugars include aldoses or ketoses such as glucose, fructose, maltose, lactose, glyceraldehyde, dihydoxyacetone, arabinose, xylose, ribose, mannose, erythrose, threose, and galactose. The at least one polyol may be an alkane polyol. Alkane polyols are known to react with amino compounds such as proline to form aromas [U.S. Pat. No. 3,425,840]. Suitable alkane polyols include for example glycerol, erythritol, xylitol, ribitol, sorbitol, dulcitol, mannitol, isomalt, maltitol and lactitol. The at least one polyol may be in the form of a hydrate, for to example glucose monohydrate or rhamnose monohydrate. The at least one polyol may be selected from the group consisting of sorbitol, glucuronic acid, 5-keto-gluconic acid, galacturonic acid, iduronic acid, maltodextrin, glucose syrup, rhamnose, xylose, glucose, fructose, sucrose, lactose, maltose, xylitol, maltitol, erythritol, mannitol, galactose and mixtures of these. For example, the flavour precursors may comprise fructose and lysine; glucose and lysine; rhamnose and lysine; fructose and glysine; glucose and glysine; rhamnose and glysine; fructose and proline; glucose and proline; or rhamnose and proline.

It is advantageous that the process of the invention does not require heat to generate a flavour composition. High temperatures can lead to losses of volatile compounds and may introduce undesirable “burnt” flavours. The temperature of the mixture during milling in the process of the invention may not rise above 100° C., for example not above 80° C., for example not above 60° C., for example not above 50° C. for further example not above 45° C.

Mechanical energy is transferred to the flavour precursors more effectively when there is a high resistance to the shearing forces of the mill. This may be achieved by having a high proportion of solid material in the mill. The total liquid phase present in the mixture during milling may be less than 20 wt. %, for example less than 10 wt. %, for further example less than 5 wt. %.

Milling may be performed in any of the type of apparatus known in the art for this purpose. For example the milling may be performed in a jet mill, a ball mill, a disc mill, a hammer mill, a roller mill. The milling may be performed in an apparatus which provides sufficient shear force to cause a reduction in particle size, for example the milling may be performed in an extruder such as a twin-screw extruder.

The flavour composition obtainable by the process of the invention may be used to flavour a food product. The process of the invention produces a different flavour profile to that obtained by conventional processes. The low level of solvent, the solid nature of the reactants and the specific nature of mechanical energy input leads to different proportions of flavour and aroma molecules in the flavour composition to those produced conventionally. An aspect of the invention is a food product comprising the flavour composition obtainable by the process of the invention. In the context of the present invention, the term “food” includes substances that people or animals eat or drink, typically to provide nutrition or to quench thirst. The flavour composition prepared by the process of the invention is preferably formed from components which are all food grade. It is advantageous not to have to remove any non-food grade material, for example a non-food grade solvent, before using the flavour composition in a foodstuff. By using flavour precursors in the solid state the resulting flavour composition may be highly concentrated. For example, it may have low levels of water. The flavour composition may be added directly to a finished foodstuff, for example as a tastant sprayed onto extruded dog food, or the flavour composition may be incorporated as an ingredient in a part-finished product which is further processed, for example being added to a wafer batter before baking. The flavour composition may develop additional aroma compounds during further processing of the foodstuff. The food product of the invention may be a bakery product, a pet food, a dairy product, a confectionery product, a cereal product (for example a breakfast cereal) or a culinary product. Culinary products are food compositions typically prepared or used in kitchens. Culinary products which may comprise the flavour composition according to the invention include soups, sauces, bouillon, liquid seasonings and prepared meals. The dairy products may be for example milk-based powders, ice creams, cheese, fermented milks, and yogurt.

The food product of the invention may be a beverage in a form which is ready to drink, a product which is used to prepare a beverage for example by the addition of water, or a product which is added to a beverage such as a beverage enhancer. The food product of the invention may be a coffee product, a tea product, a milk drink, a cocoa beverage or a malt beverage.

Those skilled in the art will understand that they can freely combine all features of the present invention disclosed herein. In particular, features described for the process of the present invention may be combined with the product of the present invention and vice versa. Further, features described for different embodiments of the present invention may be combined. Where known equivalents exist to specific features, such equivalents are incorporated as if specifically referred to in this specification. Further advantages and features of the present invention are apparent from the non-limiting examples and figures.

### EXAMPLES

### Example 1

### Preparation of Flavour Compositions

Three mixtures A, B and C were prepared with the compositions below.

| | A | B | C |
|---|---|---|---|
| Polyol | 3.28 g rhamnose | 3.60 g glucose | 3.60 g fructose |
| | monohydrate | (anhydrous) | (anhydrous) |
| Amino | 2.30 g proline | 2.30 g proline | 2.30 g proline |
| compound | | | |
| Buffer | 0.28 g Na₂HPO₄ | 0.28 g Na₂HPO₄ | 0.28 g Na₂HPO₄ |

The mixtures were ball-milled using a Retsch ball mill for 20 minutes using four 15 mm balls and a frequency of 15 Hz. The temperature immediately after ball-milling of the mixtures within the mill was measured by infra-red thermometer and found to be around 35° C. The energy applied was approximately 20 Wg⁻¹. The particle size distribution of mixture A was measured using a Malvern Mastersizer 3000 and had a D90 of 473 μm before ball-milling and 110 μm after ball-milling. After ball-milling the samples were stored in a sealed plastic container. For comparison, a second set of the mixtures A, B and C were prepared, but simply dry-mixed for 20 minutes.

The resulting samples were assessed by a sensory panel of six panellists who recorded the odour intensity on a scale of 0 (no odour) to 5 (very strong odour). The results are given in table 1 below.

TABLE 1

| A: Rhamnose•H₂O/ | | | | | |
|---|---|---|---|---|---|
| Proline | | B: Glucose/Proline | | C: Fructose/Proline | |
| Ball-mill | Dry-mix | Ball-mill | Dry-mix | Ball-mill | Dry-mix |
| 3.5 | 1.0 | 3.4 | 0.6 | 2.3 | 0.6 |

The ball-milled samples were found to have significant odours whereas the samples which had simply been mixed had very little odour.

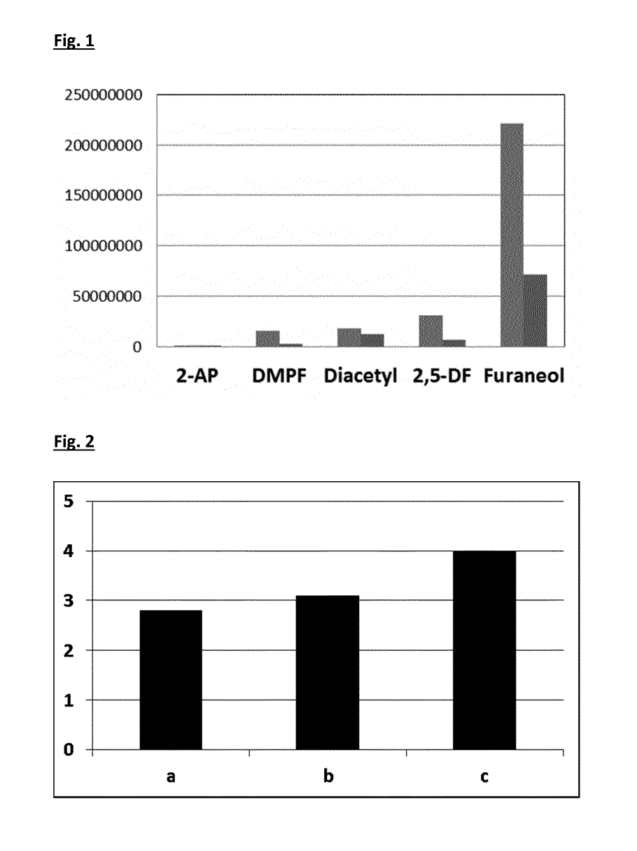

The generation of Maillard products by milling a rhamnose proline mixture (A) was studied using a relative solid-phase microextraction gas chromatography-mass spectrometry (SPME-GCMS) quantification with integrated MS response area performed directly on the solid mixtures. Rhamnose and proline were milled individually prior to mixing. A physical mixture was then achieved by manually mixing the two powders. One sample was analysed as a reference without further processing (manually mixed), but a second sample (ball-milled sample) was further processed by being milled for 20 minutes in a Retsch Vibratory Ball mill (2 steel balls with 15 mm diameter at 15 Hz). The results are displayed in FIG. 1. It can be seen that milling a mixture of flavor precursors generates greater quantities of aroma compounds such as 2,5-dimethyl-4-(1-pyrrolidinyl)-3(2H)-furanone, diacetyl, 2,5-dimethylfuran and furaneol, than simply combining milled flavor precursors.

### Example 2

### Ball-Milling Samples with and without Buffer

Four mixtures D, D_{buff}, E, and E_{buff} were prepared with the compositions below. They were evaluated by a sensory panel as in Example 1, the odour intensity is also shown in table 2 below.

TABLE 2

| | D | D_{buff} | E | E_{buff} |
|---|---|---|---|---|
| Polyol | 3.60 g fructose | 3.60 g fructose | 3.28 g rhamnose•H₂O | 3.28 g rhamnose•H₂O |
| Amino | 2.30 g lysine•HCl | 2.30 g lysine•HCl | 2.30 g proline | 2.30 g proline |
| compound | | | | |
| Buffer | — | 0.28 g Na₂HPO₄ | — | 0.28 g Na₂HPO₄ |
| Odour | 0.8 | 1.8 | 3.0 | 3.5 |
| intensity | | | | |

The addition of a buffer increased the generation of odour during milling.

### Example 3

### Preparation of Wafers

Rhamnose and Proline were used as flavour precursors in baked wafers. Three types of wafer were prepared from a standard flour-based wafer batter with the addition of proline and rhamnose. The batter recipe remained the same for all three samples, but the proline and rhamnose were prepared in different ways:

a) rhamnose and proline used as supplied

b) rhamnose and proline were micronized (milled) individually

c) rhamnose and proline ball-milled together for half an hour.

Ball-milling was performed in a Retsch vibratory ball-mill for 30 minutes with 4 steel balls (diameter 15 mm) at a frequency of 15 Hz.

The three different wafer batters were baked at 160° C. for 90 seconds. The wafers were cooled down to room temperature, sealed in aluminium sachets and evaluated the next day.

The samples were presented blind-coded and in a randomized manner; panelist were asked to rate the odor intensity on a scale from 0 to 10. Results are shown in FIG. 2.

A clear trend may be observed that milling the rhamnose and proline together generates the wafer with the highest aroma intensity.

For analytical measurements, further wafers were prepared with the same relative ingredient composition but on a greater scale and with larger scale equipment. This time, four samples of flavour precursor mixtures were prepared.
a) reference sample where proline (23%) was manually mixed with rhamose (77%) in a sealed plastic bag (materials used as supplied) until complete homogenization was achieved on multi-kilogram scale.
b) micronized sample where the mixture was micronized (milled) for about 5 minutes using a Frewitt HammerWitt hammer-mill.
c) mechanically treated sample, where micronized material was prepared as for (b), but additionally treated in a horizontal FKM Laboratory Mixer/Granulator from Loedige for two hours at 30° C. (<<ball-milled>>)
d) mechanically treated sample, where micronized material was prepared as for (b), but additionally treated in a horizontal FKM Laboratory Mixer/Granulator from Loedige for two hours at 30° C. spraying a catalytic amount of water on top of the mixture using a nebulizer (<<ball-milled with water>>)

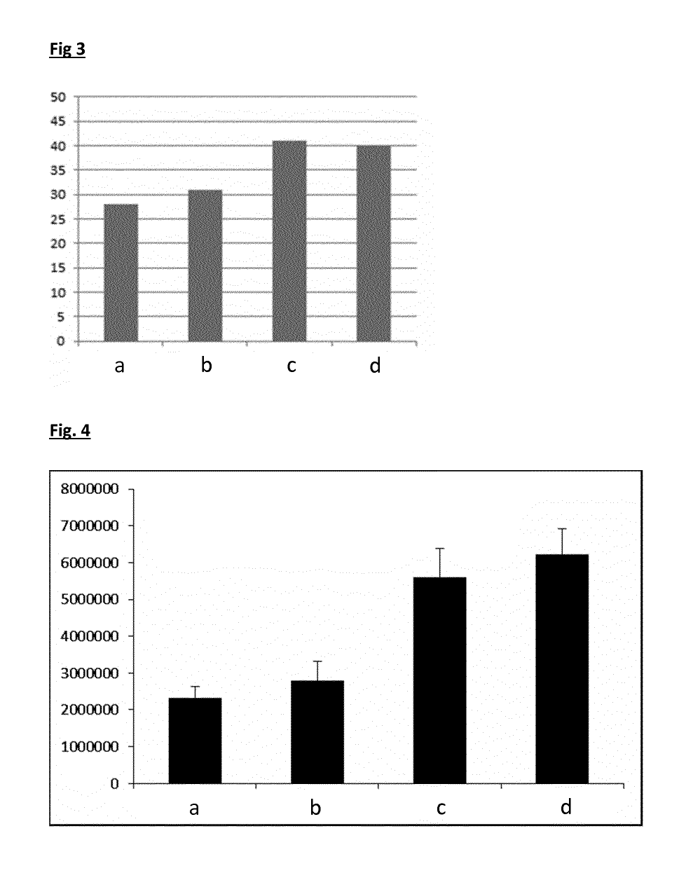

Aroma intensity from the baked wafers was assessed by a panel (FIG. 3), and furaneol was quantified using SPME-GCMS (FIG. 4). The generation of aroma is significantly higher when the precursors are milled together.

1. Process for generating a flavor composition comprising: milling a mixture comprising flavor precursors in a solid state and between 0.0001 and 10 wt. % edible solvent, wherein the flavour precursors in the solid state comprise at least one polyol with at least one amino compound selected from the group consisting of amino acids, amino acid derivatives and peptides and wherein the total weight in the solid state of polyols and amino compounds selected from the group consisting of amino acids, amino acid derivatives and peptides is at least 20% of the weight of the milled mixture.

2. A process according to claim 1 comprising the step of adding edible solvent to the mixture after milling.

3. A process according to claim 1 wherein the edible solvent is selected from the group consisting of water, glycerol, ethanol, propylene glycol, ethyl acetate, acetone, isopropanol, triethylcitrate, triacetin and mixtures of these.

4. A process according to claim 1 wherein the mixture further comprises a buffer.

5. A process according to claim 4 wherein the buffer is a salt selected from the group consisting of phosphates, citrates, lactates, carbonates, acetates, hydrogencarbonates, hydrogenphosphates and mixtures of these.

6. A process according to claim 1 wherein the mixture contains a molar ratio of polyol to amino compound of between 1:0.01 and 1:100.

7. A process according to claim 1 wherein the amino compound is selected from the group consisting of glycine, alanine, valine, norvaline, leucine, norleucine, aspartic acid, glutamic acid, asparagine, glutamine, arginine, lysine, serine, threonine, proline, tyrosine, cysteine, cystine, methionine, phenylalanine, histidine, tryptophan, dihydroxyphenylalanine, taurin, thiamine, carno sine, glutathione, their salts and mixtures of these.

8. A process according to claim 1 wherein the polyol is a reducing sugar.

9. A process according to claim 1 wherein the polyol is selected from the group consisting of sorbitol, glucuronic acid, 5-keto-gluconic acid, galacturonic acid, iduronic acid, maltodextrin, glucose syrup, rhamnose, xylose, glucose, fructose, sucrose, lactose, maltose, xylitol, maltitol, erythritol, mannitol, galactose and mixtures of these.

10. A process according to claim 1 wherein the temperature of the mixture during milling does not rise above 100° C.

11. A process according to claim 1 wherein the total liquid phase present in the mixture during milling is less than 20 wt. %.

12. A food product comprising a flavor composition obtainable by a process comprising: milling a mixture comprising flavor precursors in a solid state and between 0.0001 and 10 wt. % edible solvent, wherein the flavour precursors in the solid state comprise at least one polyol with at least one amino compound selected from the group consisting of amino acids, amino acid derivatives and peptides and wherein the total weight in the solid state of polyols and amino compounds selected from the group consisting of amino acids, amino acid derivatives and peptides is at least 20% of the weight of the milled mixture.

13. Food product according to claim 12 wherein the food product is selected from the group consisting of a bakery product, a pet food, a dairy product, a confectionery product, a cereal product and a culinary product.

14. Food product according to claim 12 wherein the food product is selected from the group consisting of a coffee product, a tea product, a milk drink, a cocoa beverage and a malt beverage.
